(19) United States
(12) Patent Application Publication
(10) Pub. No.: US 2007/0228597 A1
(43) Pub. Date: Oct. 4, 2007

(54) Swirl material

(76) Inventors: William John Mutton, Colborne (CA); Gregory Arnold Brooker, Wake Forest, NC (US); Marvin Langer, Emek Beit shean (IL)

Correspondence Address: HOFFMANN & BARON, LLP, 6900 JERICHO TURNPIKE, SYOSSET, NY, 11791, US

(21) Appl. No.: 11/394,134

(22) Filed: Mar. 30, 2006

(51) Int. Cl. B29C 47/60

(52) U.S. Cl. 264/148; 264/211.23

(57) ABSTRACT

This invention relates to extruded material having swirled coloured appearance. Two polyolefin mixtures are prepared. The two mixtures are generally the same except that one is of a first colour and the second of a second colour. Each of the first and second mixtures are kneaded in respective dispersion kneaders. The resulting melt from each kneader is cut into random sized pieces. The random sized pieces of the two melts are placed in a hopper of an extruder and the extruder operated to force the random mixture through a die. The resultant product has a first colour with a random swirled pattern of the second colour. The resultant product is then cured.

### FIELD OF THE INVENTION

This invention relates to extruded materials having swirled colour appearance.

### BACKGROUND OF THE INVENTION

Extruded articles are available in an array of colours and styles for a variety of applications. When the extruded articles are foams they can be used for various purposes including packaging and other aspects. In some situations, such as in the packaging industry, swirled materials are particularly advantageous as they aid in recognition of materials packed within the unusually coloured packaging foams.

### SUMMARY OF THE INVENTION

In accordance with the invention, two low density polyolefin mixtures are prepared. The two mixtures are generally the same except that one mixture is of a first colour and the second mixture is of a second colour. The first and second colours may be natural colours or the result of adding colour materials. The first mixture is loaded into a first dispersion kneader while the second mixture is loaded into a second dispersion kneader. The kneaders are then operated in accordance with the usual operating conditions required of the constituent ingredients. Once the kneaders have completed their cycle, the melt resulting from each kneader is discharged into a separate collection vessel. The next step in the process is the cutting of the two melts into random sized pieces. The random sized pieces of the cut melt from the first dispersion kneader and the second dispersion kneader are randomly loaded into the hopper of an extruder. The extruder is then operated so that the flow of material from the hopper of the extruder into the extruder screw is randomly selected. The extruder extrudes the material through a die and the material extruded through the die then has a swirl pattern. The material leaving the extruder can then be loaded into a premolding oven and finished to a desired state.

### BRIEF DESCRIPTION OF THE DRAWINGS

FIG. 1 is a flow chart showing a process in accordance with one embodiment of the invention, and

FIG. 2 is an image of the extruded article with the distinct swirl pattern made in accordance with the process of FIG. 1.

### DETAILED DESCRIPTION OF THE INVENTION

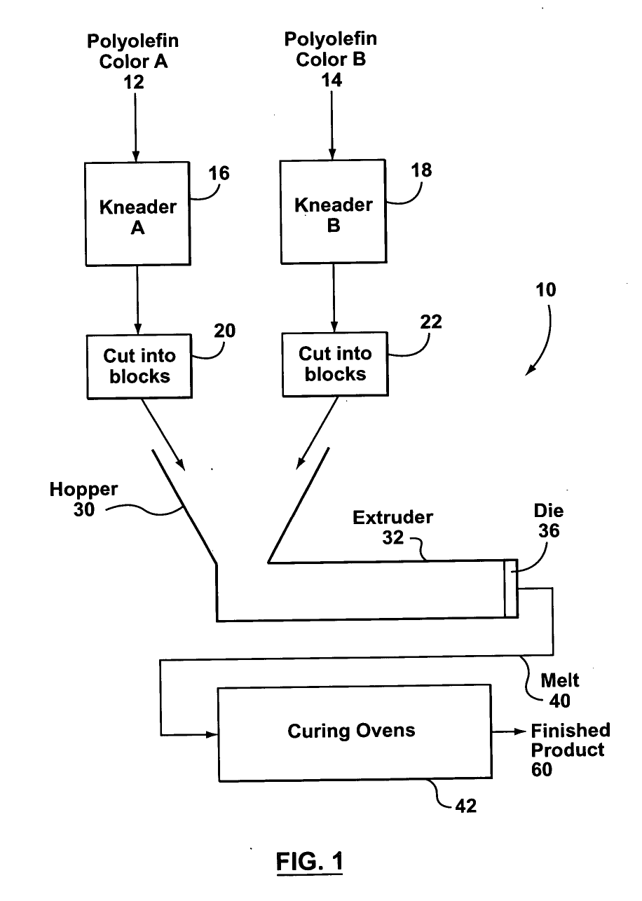

FIG. 1 illustrates the process generally at 10. The initial step in the process is to select a particular low density highly branched polyolefin as desired for the end product. Depending upon the particular chemical nature of the polyolefin, certain other ingredients typically used in this industry may be used. These include processing aids, colour additives, cross-linking agents, gas exchange additives and cell nucleating agents. Two batches 12, 14 are prepared. The batches may be identical or slightly different but compatible. The major difference between the two batches is the colour ingredients of the batches. The first batch to be loaded into kneader A 16 may be the natural colour of the chemical formulation or have a first colouring agent added to it. Conveniently the first colouring agent may be chosen to give the finished product emanating from kneader A, the colour white. The second batch to be loaded into kneader B 18, will have a colouring agent added to it so that that batch has a different colour than the material added to kneader A. Any suitable colouring agent may be added and the percentage of colouring agent used is open to selection by the operator of the process.

When both formulations have been prepared, they are added to kneaders A and B respectively. The kneaders are what is referred to in this industry as dispersion kneaders. This equipment takes a mix of resin and chemicals and turns it into a homogeneous melt. This is accomplished through the heating of the jacket and rotors with hot water, pressure applied by a lid attached to a piston and tapered rotors which help shear the polyolefin pellets. An example of a suitable dispersion kneader is that sold under the trade mark TOSHIN HTC50™.

Typically each kneader will operate until all the steps and set points are met which are controlled by the PLC outlined in the program selected by the operator of the process. The material then is discharged from each of kneader A and kneader B. These individual batches are cut into random sized chunks, preferably in the range of 2 to 5 kilos, more preferably 2 to 3 kilos. At this stage, the only difference in the two materials will be the colour of the product that has been discharged from the respective kneader.

After the materials discharged from kneader A and kneader B respectively have been cut into random sized blocks 20, 22, the cut materials are randomly charged to a hopper 30 of an extruder 32. Typically the hopper of such extruders have a capacity of between 75 and 150 liters. Therefore, several dozen of the 2 to 5 kilogram pieces can be added to the hopper of the extruder in a random order. If there is more material available from kneader A and kneader B than can be conveniently loaded in the hopper of the extruder at one time, the hopper may be continuously recharged in the same random fashion while the extruder continues to operate.

An extruder which can conveniently be used to carry out the process is the Toshin HTC-50™. This extruder is operated in accordance with the normal operating conditions for the extruder and the selected low density polyolefin.

The process then results in a melt 46 that comes out of the extruder die opening 36. That melt is cut into suitable sized weights. The suitable sized weights are determined by the loading capacity of any standard premolding oven. The melt is charged to the premolding oven 46 and then the oven procedure is conducted in the usual fashion.

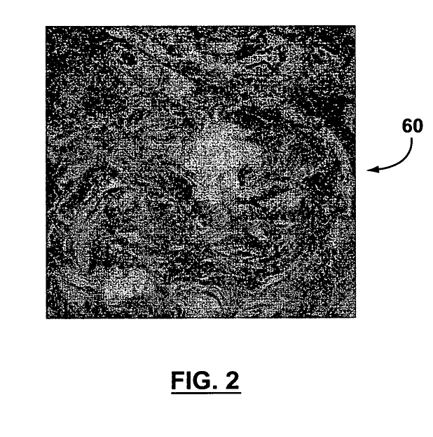

The product that will be discharged from the premolding oven is then charged into the First Foaming Oven (Hernsen)™ where the cross-linking process controlled under pressure and activated by heat is carried out. The material which emerges is a foamed polyolefin material in which there is a base pattern and a swirl effect of the coloured material. From the first foaming ovens the cross-linked foam is either left for cooling in a 1 step process or transported to the second Foaming Ovens (Fong Dein)™ where the final step of expansion is completed. Then the finished swirl foam a cross section of which is shown in FIG. 2 at 60, can be cut and shaped into convenient configurations for use in the packaging industry or for other uses as desired.

The following example exemplifies an application of the invention.

In kneader A low density polyethylene resin (Dow, Equistar, Nova)™ is processed with the aid of heat and pressure to allow for the resin to melt. Then the processing aids (carbo-wax), density builders (calcium carbonate, talc), cross-linking agents (peroxides), a single colour additive (blue for example), is added to the mixture along with blowing agents (azodicarbonamide). At the same time, in kneader B the same low density polyethylene resin is processed with all the same ingredients and same quantities of processing aids, density builders, cross-linking agents and blowing agent for the exception of the colour (white for example). Once all the processing steps are completed in the mixing stage the melts are discharged onto carts positioned in front of each Banbury™ mixer. The melts are then cut into many 2 kg-3 kg pieces until each melt is totally consumed and loaded into the elevator for transportation to the extruder. Once the extruder is full of these random pieces of material, the extruder is activated and the screw commences to rotate resulting in a profile of material being pushed out of the head (FIG. 2). This profile will represent the blending of the 2 primary colours (blue & white in this example). As the profile is extruded the operator will cut the profile to the desired weight for loading in the next stage of foaming. At this point the “swirl” pattern of the foam will be established and finally foaming and expansion will occur.

1. The process of extruding a swirl patterned article comprising the steps of:
preparing a first material and a second material,
the first and second materials comprising a polyolefin resin and other chemicals,
at least one of said first and second materials including a colour agent additive so as to differentiate the colour of the first and second materials, charging the first material to a first kneader,
charging the second material to a second kneader,
operating the kneaders substantially contemporaneously for a substantial period of time,
discharging the material from said first kneader and cutting said discharged material from said first kneader into random size blocks of between two and five kilograms each,
discharging material from the second kneader, cutting said discharged material from said second kneader into random size blocks of between one to five kilograms each,
randomly selecting cut blocks of first kneaded material and the second kneaded material and charging said selected blocks to the hopper of an extruder, and operating the extruder to extrude a melt.

2. The process of claim 1 wherein said melt from said extruder is charged to a curing oven.

3. The process of claim 2 wherein said blocks are cut into sizes of between 2 and 5 kilograms.

4. The process of claim 3 wherein the blocks are cut to a size of between 2 and 3 kilograms each.
